(19) United States
(12) Patent Application Publication
(10) Pub. No.: US 2023/0364565 A1
(43) Pub. Date: Nov. 16, 2023

(54) Stirring element device and method for producing a stirring element device

(71) Applicant: EKATO Rühr-und Mischtechnik GmbH, Schopfheim (DE)

(72) Inventors: Hans-Jürgen WEISS, Kandern (DE); Benjamin MULTNER, Wehr (DE); Wolfgang KELLER, Village Neuf (FR); Wolfgang LAST, Lörrach (DE)

(21) Appl. No.: 18/025,631

(22) PCT Filed: Sep. 6, 2021
(86) PCT No.: PCT/EP2021/074509

§ 371 Date: Mar. 9, 2023

(30) Foreign Application Priority Data
Sep. 9, 2020 (DE) 10 2020 123 520.8

(51) Int. Cl. B01F 27/1142; B01F 27/808; B01F 27/1144

(52) U.S. Cl. CPC B01F 27/1142; B01F 27/808; B01F 27/1144

(57) ABSTRACT

A stirring element device, in particular for stirring fluidized beds and/or solid matter mixtures and/or highly viscous suspensions, comprises at least one helical stirrer, which is rotatable around a rotation axis and has at least one winding that runs around the rotation axis, wherein the helical stirrer comprises a base body, which has in at least one cross-sectional view an at least section-wise oval, in particular circle-shaped, outer contour.

### STATE OF THE ART

The invention concerns a stirring element device according to the preamble of claim 1 and a method for producing a stirring element device according to the preamble of claim 13.

The usage of helical stirrers is already known from the state of the art. Helical stirrers are used in different industries and in different procedures, for example for a mixing of solid matter. A particularly demanding field of application of helical stirrers is herein the production of polymers, for example the gas phase polymerization of polyethylene or polypropylene, wherein a gas phase is stirred into a bulk of solid matter. Methods of this type are typically implemented in large reactors with volumes of 50 m³ and more, with correspondingly large torques and further mechanical forces acting onto the helical stirrer, which moreover often must be made self-supporting in an open construction due to process-related reasons. This results for this type of methods in very high requirements regarding a mechanical strength of the helical stirrer, a geometry of the helical stirrer being at the same time adapted specifically to these methods.

In the document DE 12 18 165 A1 a helical stirrer is proposed which is formed of a hollow profile with a rectangular or triangular cross section. A disadvantage is herein a very high effort that is necessary for the shaping of the helical stirrer because of the special requirements regarding its geometry. Moreover, as the helical stirrer is implemented in one piece, there are further disadvantages in handling and transport due to its huge weight, in particular for the use in large reactors.

The objective of the invention is in particular to provide an advantageous further development of a generic device. The objective is achieved according to the invention by the features of patent claims 1 and 13 while advantageous implementations and further developments of the invention may be gathered from the subclaims.

### Advantages of the Invention

The invention is based on a stirring element device, in particular for stirring fluidized beds and/or solid matter mixtures and/or highly viscous suspensions, with at least one helical stirrer, which is rotatable around a rotation axis and has at least one winding that runs around the rotation axis.

It is proposed that the helical stirrer comprises a base body which has, in at least one cross sectional view, an at least section-wise oval, in particular circle-shaped, outer contour.

Such an implementation advantageously allows providing a stirring element device having improved efficiency, with component tensions and rigidity being comparable to known stirring element devices. In particular, it is advantageously possible to provide a stirring element device with an increased torsional rigidity. In this way advantageously an especially reliable and long-lived stirring element device can be provided. By the implementation of the stirring element device according to the invention moreover a particularly efficient utilization of material is enabled. Furthermore, in addition to a reduced material input in the production of the stirring element device, saving of weight is advantageously achievable, as a result of which a handling effort and transport effort are considerably reducible. Moreover, a manufacturing effort and a manufacturing time are advantageously reducible. Due to the aforementioned advantageous characteristics of the stirring element device, it is moreover advantageously possible to achieve saving of costs when producing and/or assembling the stirring element device.

A “stirring element device” is in particular to be understood as an operable component, in particular a structural and/or functional component, of an agitator, which comprises at least the helical stirrer. The stirring element device is in particular configured for stirring solid matter mixtures and/or highly viscous suspensions. The stirring element device may be configured to be used in a great variety of industrial processes. Preferably the stirring element device is configured to be used in procedures of plastic production and/or plastic processing, in particular for the production of polypropylene in a gas phase polymerization, in particular in reactors having a volume of 50 m³ or more.

The helical stirrer is rotatable around a rotational axis and has at least one winding that runs around the rotation axis, wherein the rotation axis preferably extends parallel to a longest edge of a smallest geometrical cylinder which just still completely encloses the helical stirrer. In a view perpendicularly onto the rotation axis, the at least one winding of the helical stirrer running around the rotation axis forms a curve which winds around the rotation axis with a complete 360-degree rotation with a, preferably constant, gradient oriented in the direction of the rotation axis, along an inner enveloping surface of the smallest geometrical cylinder which just still completely encloses the helical stirrer. The helical stirrer preferably has a plurality of successive windings running around the rotation axis. Preferably the windings have in each case at least substantially the same gradient along the direction of the rotation axis, and the helical stirrer has the shape of a helix, of a screw, of a helical line or of a cylindrical spiral. The windings may run around the rotation axis either clockwise or anti-clockwise. The course of the windings of the helical stirrer in a view direction along the rotation axis will in the following be designated as the principal course of the helical stirrer. Preferably the helical stirrer is implemented so as to be self-supporting. Alternatively to a self-supporting helical stirrer, it would be conceivable that the helical stirrer comprises at least one stabilization element. The stabilization element could, for example, be arranged at an angle to the principal course of the helical stirrer, connecting for example at least one winding of the helical stirrer to at least one further winding of the helical stirrer for the purpose of a stabilization of the helical stirrer. Preferably the helical stirrer can be partitioned into several segments. A segment could, for example, comprise a half winding running around the rotation axis of the helical stirrer, wherein any smaller or larger segments are also conceivable. In an assembled state, the segments of the helical stirrer may be connected to one another via a form-fit and/or force-fit connection, for example by a screw connection. Alternatively or additionally, the segments could in the assembled state be connected to one another via substance-to-substance bond, for example welded. By such an implementation a transport of the stirring element device is advantageously improvable. It is also conceivable that the helical stirrer can be expanded by further additional segments, thus advantageously improving a flexibility of a usage of the stirring element device.

By “at least substantially” is to be understood, in this context, that a deviation from a given value is less than 25%, preferably less than 10% and particularly preferentially less than 5% of the given value.

Preferably the base body forms a load-bearing basic structure of the helical stirrer and is configured for receiving the mechanical forces and moments, in particular torques and/or torsional moments, acting onto the helical stirrer in an operating state of the stirring element device. Preferably the base body is connectable, for example via a drive shaft, to a drive unit, which may be part of the stirring element device or part of an agitator comprising the stirring element device, and is configured for receiving a drive moment provided by the drive unit, using said drive moment to put the helical stirrer into a rotational movement around the rotation axis. Preferably, in the at least one cross-sectional view, the at least section-wise oval, in particular circle-shaped, outer contour of the base body is oval, preferably circle-shaped, over at least one section which extends over an angle of 180 degrees. The outer contour is preferably over the entire cross-sectional view oval, in particular circle-shaped. Preferably the base body extends along the entire principal course of the helical stirrer. Preferably the base body has a section-wise oval, in particular circle-shaped outer contour in all cross-sectional views along the principal course of the helical stirrer. Preferably, the outer contour of the base body has along the entire principal course of the helical stirrer an at least substantially constant diameter in the cross-sectional view.

“Configured” is in particular to mean specifically designed and/or equipped. By an object being configured for a certain function is in particular to be understood that the object fulfills and/or executes said certain function in at least one application state and/or operation state.

It is further proposed that the helical stirrer comprises a stirring blade, which is connected to the base body. Advantageously, by the stirring blade which is connected to the base body, independently from the shape of the base body a special geometry of the helical stirrer is achievable, which can be adapted to different individual procedural requirements in a particularly flexible manner. Due to the stirring blade being connected to the base body, other than in stirring blade implementations of helical stirrers known from the state of the art, the stirring blade itself no longer has a load-bearing function, which advantageously results in an enhanced flexibility in regard to a geometrical implementation and/or to a selection of materials for the stirring blade. Advantageously there is also, in particular in stirring element devices configured to be used in large-volume reactors and therefore having corresponding size and weight, the possibility of transporting the stirring blade and the base body separately, connecting them to each other on-site, such that a transport and/or a handling during assembly can be simplified.

The stirring blade could be connected to the base body in a form-fit and/or force-fit connection, for example by a screw connection or something like that. However, in an advantageous implementation it is proposed that the stirring blade is connected to the base body by substance-to-substance bond. In this way, advantageously a particularly reliable connection of the stirring blade to the base body is achievable with simple technical means. The stirring blade could be connected to the base body in a substance-to-substance bond, for example by a soldering connection and/or a welding connection and/or a gluing connection and/or by vulcanization. The substance-to-substance bond between the stirring blade and the base body may herein be realized directly or indirectly via a further element, which is respectively connectable to the base body and to the stirring blade by substance-to-substance bond.

Furthermore it is proposed that the helical stirrer comprises at least one connection element, which connects the stirring blade to the base body. This advantageously allows further improving a connection between the stirring blade and the base body. Preferably the connection element is connected to the stirring blade and to the base body in each case by substance-to-substance bond. Preferably the connection element has an inner contour which encompasses the outer contour of the base body at least partially. Preferably the helical stirrer comprises a plurality of connection elements, which are embodied at least substantially identically to each other and are arranged spaced apart, in particular at equal distances from each other, along the principal course of the helical stirrer. This advantageously enables a particularly reliable connection between the stirring blade and the base body as well as an especially even force transfer from the base body to the stirring blade.

The base body may extend along the stirring blade only partially. However, in an advantageous implementation it is proposed that the base body extends along the entire stirring blade, in particular along the principal course. Such an implementation advantageously allows providing an especially stable helical stirrer, in particular a helical stirrer having a high torsional strength. Advantageously, moreover an especially even force transfer of a drive moment from the base body to the stirring blade is enabled, as a result of which an especially even stirring result is advantageously achievable.

It is also proposed that the stirring blade has an at least substantially planar surface on a side facing away from the base body. Such an implementation advantageously allows improving a stirring result. The at least substantially planar surface is preferably implemented so as to be macroscopically smooth. Preferably the at least substantially planar surface has an, in particular even, gradient along the principal course of the helical stirrer and is in a direction perpendicularly to the principal course implemented free of macroscopic unevenness, in particular free of macroscopic elevations and/or deepenings. It would be conceivable that the stirring blade has a coating that is applied to the planar surface and could, for example, be configured for a protection from abrasion of the planar surface.

The stirring blade could in the cross-sectional view have a transverse extent that is smaller than a diameter of the outer contour of the base body or corresponds to the diameter of the outer contour. However, in an advantageous implementation it is proposed that in the cross-sectional view a transverse extent of the stirring blade is greater than a diameter of the outer contour of the base body. Such an implementation advantageously allows improving a stirring result. By a “diameter of the outer contour” is herein a diameter of a smallest circle to be understood which just still encompasses the outer contour. The transverse extent of the stirring blade runs at least substantially perpendicularly to the principal course of the helical stirrer. The term “substantially perpendicularly” is herein in particular intended to define an orientation of a direction relative to a reference direction, wherein the direction and the reference direction, in particular when viewed in a projection plane, include an angle of 90 degrees and the angle has a maximum deviation that is in particular smaller than 8 degrees, advantageously smaller than 5 degrees and especially advantageously smaller than 2 degrees. Preferably the transverse extent of the stirring blade is at least substantially constant along the entire principal course.

Beyond this it is proposed that in the cross-sectional view the stirring blade has a thickness that is equivalent to maximally 20% of a diameter of the outer contour of the base body. In this way saving of material is advantageously achievable. Advantageously it is moreover possible to improve a production process. In addition, advantageously a flexibility of a geometric implementation of the stirring blade can be increased if the stirring blade has a thickness that is small with respect to the diameter of the outer contour of the base body. Preferably, in the cross-sectional view the stirring blade has a thickness that is maximally 15%, particularly preferably maximally 10% of the diameter of the outer contour of the base body. Preferably the stirring blade is implemented of a metal sheet having a thin material thickness, which at least substantially corresponds to the thickness of the stirring blade in the cross-sectional view.

It is furthermore proposed that the stirring element device comprises a cover unit with at least one cover element, which extends at least partly along the entire base body, covering the base body at least partly, preferably completely, in at least one direction that is perpendicular to the rotation axis. Such an implementation advantageously allows improving a stirring result. It is moreover advantageously possible to adapt an outer contour of the helical stirrer to procedural requirements of certain stirring processes in which the stirring element device is used with particularly simple technical instruments. Preferably the cover element extends along a major portion that amounts to at least 50%, advantageously at least 70%, especially advantageously at least 80%, preferably at least 90% of a main extent of the base body and particularly preferably along the entire base body. Preferably, the cover element covers the base body, in addition to the direction that is perpendicular to the rotation axis, in further directions, namely in at least one direction that is antiparallel to the direction that is perpendicular to the rotation axis, and in a direction that is parallel to the rotation axis and points away from the stirring blade. Preferably the cover unit comprises the cover element and at least one further cover element, which extends at least partially along the entire base body, covering the base body at least partially in a direction that is perpendicular to the rotation axis. The cover element is preferably arranged on a side of the helical stirrer that faces toward the rotation axis. Preferably the cover element is connected to the stirring blade by substance-to-substance bond, for example welded, in particular at least partially along a longest edge of the stirring blade that faces toward the rotation axis and the base body. The further cover element is preferably arranged on a side of the helical stirrer that faces away from the rotation axis. Preferably the further cover element is connected to the stirring blade by substance-to-substance bond, for example welded, in particular along a longest edge of the stirring blade, which faces away from the rotation axis and towards the base body. Alternatively, it would be conceivable that the cover element and/or the further cover element are/is implemented integrally with the stirring blade. Preferably the further cover element has in the cross-sectional view a smaller extent than the cover element. This advantageously allows optimizing a flow profile in an edge region of the helical stirrer, thus further improving the stirring result. In addition to the cover element and the further cover element, the cover unit may comprise an additional cover element. Preferably the additional cover element is connected to the cover element and the further cover element in such a way that the base body is completely encompassed perpendicularly to the cross-sectional view. Preferably the additional cover element is connected, for example welded, to the cover element and the further cover element in each case along a longest edge. Alternatively, the cover element, the further cover element and the additional cover element could be implemented in one piece, for example produced from a bent metal sheet.

The base body could be implemented of a full material, for example a bent round rod, which in at least one cross-sectional view has an at least section-wise oval, in particular circle-shaped, outer contour. However, in an advantageous implementation it is proposed that the base body is embodied as a tube. By such an implementation saving of material is advantageously achievable. It is moreover advantageously possible, component tensions and component rigidity being comparable to full material, to achieve a weight reduction. This furthermore advantageously permits considerably reducing a handling effort and/or transport effort. Preferably the tube is embodied as a bent round tube.

The invention further pertains to an agitation reactor with a stirring container and with a stirring element device according to one of the implementations described above. Preferably, in addition to the stirring container and the stirring element device, the agitation reactor comprises at least one drive unit and at least one transfer element, for example a drive shaft, which connects the stirring element device, in particular the base body of the helical stirrer, to the drive unit. The drive unit of the agitation reactor may contain, for example, without being restricted thereto, an electromotor for generating a drive moment, a clutch and/or transmission element for a transfer of the drive moment, and/or further elements.

It is also proposed that the helical stirrer is arranged in the stirring container in such a way that a wall clearance to an inner wall of the stirring container is optimized. Such an implementation advantageously allows improving a stirring result. For a suitable selection of the wall clearance to the inner wall of the stirring container a variety of influencing factors must be taken into account. Firstly, during operation mechanical forces may cause a temporary deformation of the helical stirrer, such that—similar to a compression of a metallic spring—the diameter of the helical stirrer may be enlarged and the wall clearance is reduced. The reduction of the wall clearance due to the temporary deformation of the helical stirrer herein strongly depends on the mechanical characteristics of the helical stirrer, for example a torsional rigidity and/or the self-weight of the helical stirrer. The wall clearance of the helical stirrer must furthermore be selected such that an even stirring process is enabled over an entire cross section of the stirring container. Herein the wall clearance should, on the one hand, be sufficiently small to prevent a formation of dead zones in a proximity of the inner wall of the stirring container, where media which are to be stirred will not be stirred at all or will not be stirred sufficiently. On the other hand, in particular for a stirring of fluidizing beds and/or solid matter mixtures, the selected wall clearance must not be too small as otherwise, caused by individual particles that are to be stirred, a blocking may occur in a gap between the helical stirrer and the inner wall. An optimum wall clearance must therefore be also optimized depending on a particle size and/or a distribution of particle sizes of media which are to be stirred. Preferably the wall clearance of the helical stirrer is optimized in such a way that a contact to the inner wall is prevented, even in case of a deformation in an operation state. Preferably the wall clearance of the helical stirrer is optimized such that a formation of dead zones in a proximity of the inner wall is prevented. Preferably the wall clearance of the helical stirrer is optimized in such a way that a blocking of a gap between the helical stirrer and the inner wall by particles which are to be stirred is prevented.

The invention is furthermore based on a method for producing a stirring element device with at least one helical stirrer.

It is proposed that a base body of the helical stirrer is produced from a tube having an at least section-wise oval, in particular circle-shaped, outer contour. This advantageously allows providing an especially efficient method for producing a stirring element device. It is advantageously possible to reduce a material input in comparison to customary methods, thus advantageously increasing efficiency in regard to material/s. If the base body is made of a tube having an at least section-wise oval, in particular circle-shaped, outer contour, advantageously a particularly high strength is achievable at the same time as particularly low material input. It is moreover advantageously possible to produce a helical stirrer having an especially low specific weight, thus further advantageously improving transport. It is further advantageously possible to produce a helical stirrer which is suitable for especially efficient operation due to its low specific weight, as further elements for the operation of the helical stirrer, like for example a drive motor and/or a support and/or a foundation or the like, can be given respectively smaller dimensions. Furthermore, production efforts and/or a duration of a production are advantageously reducible. Moreover, saving of costs is advantageously achievable.

It is further proposed that in the method a stirring blade of the helical stirrer is connected to the base body. Such an implementation advantageously allows providing a method with improved flexibility in regard to a geometrical implementation of the stirring blade. As the stirring blade gets connected to the base body and thus has no load-bearing function, advantageously a shaping of the stirring blade is enabled that is independent from the base body. Preferably the stirring blade is connected to the base body by substance-to-substance bond, for example via a welding process.

The stirring element device according to the invention and the method for producing the stirring element device are herein not to be limited to the application and implementation described above. In particular, in order to fulfill a functionality that is described here, the stirring element device according to the invention and the method for producing the stirring element device may comprise a number of individual elements, components and units that differs from a number given here.

### DRAWINGS

Further advantages will become apparent from the following description of the drawings. In the drawings two exemplary embodiments of the invention are illustrated. The drawings, the description and the claims contain a plurality of features in combination. Someone skilled in the art will purposefully also consider the features individually and will find further expedient combinations.

It is shown in:

FIG. 1 an agitator with a stirring element device in a schematic representation,

FIG. 2 the stirring element device with a helical stirrer, comprising a base body and a stirring blade, in a schematic side view,

FIG. 3 a schematic partial view of the base body and the stirring blade in a cross-sectional view,

FIG. 4 the helical stirrer in a schematic perspective view,

FIG. 5 a schematic diagram of a method for producing the stirring element device, and

FIG. 6 a further exemplary embodiment of a stirring element device in a schematic cross-sectional view.

### DESCRIPTION OF THE EXEMPLARY EMBODIMENTS

In the figures, of objects present in multiple form in each case only one is given a reference numeral.

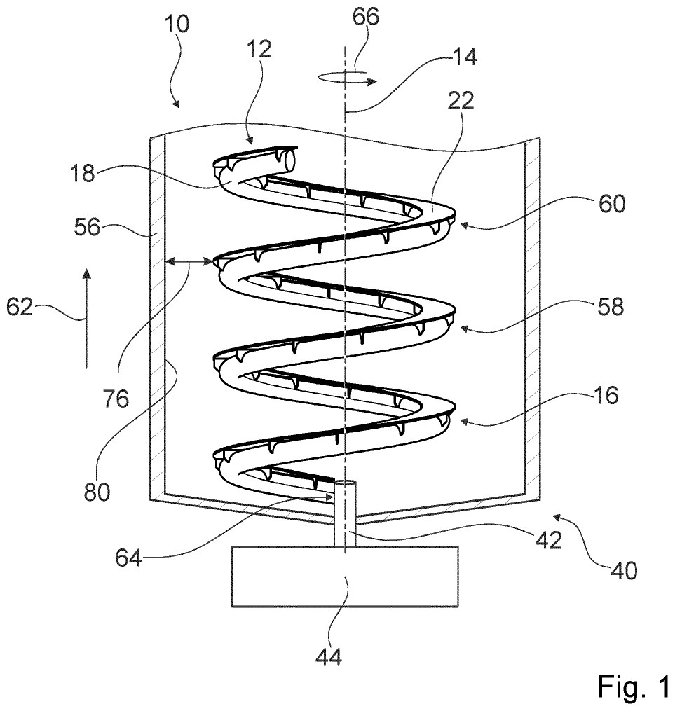

FIG. 1 shows a agitation reactor 40 in a schematic representation. The agitation reactor 40 comprises a stirring container 56. The agitation reactor 40 comprises a stirring element device 10. In FIG. 1 the stirring element device 10 is arranged in the stirring container 56 of the agitation reactor 40. The agitation reactor 40 comprises a drive unit 44. The stirring element device 10 is connected to the drive unit 44 of the agitation reactor 40 via a drive shaft of the agitation reactor 40.

The stirring element device 10 is configured for stirring fluidized beds and/or solid matter mixtures and/or highly viscous suspensions. The stirring element device 10 comprises a helical stirrer 12. The helical stirrer 12 is rotatable around a rotation axis 14. The helical stirrer 12 has at least one winding 16 running around the rotation axis 14. Starting from the drive shaft 42 of the agitation reactor 40, the winding 16 has a substantially constant gradient along a main extent direction 62 of the helical stirrer 12 and winds around the rotation axis 14 in a complete 360-degree turn. In the present case the helical stirrer 12 has a plurality of windings which follow each other in the main extent direction 62 and run around the rotation axis 14, namely the winding 16, a further winding 58 and a further winding 60. The further windings 58, 60 have a gradient that is substantially identical to the gradient of the winding 16, and in each case wind around the rotation axis 14 in a complete 360-degree turn. The helical stirrer 12 has in its main extent direction 62 the shape of a helix.

The helical stirrer 12 comprises a base body 18. The base body 18 of the helical stirrer 12 is connected to the drive shaft 42 of the agitation reactor 40 in a connection point 64. The helical stirrer 12 is implemented so as to be self-supporting. In an operating state of the agitation reactor 40, a drive momentum provided by the drive unit 44 is transferred from the drive shaft 42 to the base body 18 of the helical stirrer 12 and makes the helical stirrer 12 execute a rotational movement in a rotational direction 66 around the rotation axis 14.

The helical stirrer 12 of the stirring element device 10 is arranged in the stirring container 56 of the agitation reactor 40 in such a way that a wall clearance 76 to an inner wall 80 of the stirring container 56 is optimized. In the present case the wall clearance 76 is 75 mm. In the present case the wall clearance 76 of the helical stirrer 12 to the inner wall 80 of the stirring container 56 is optimized in such a way that in an operating state of the agitation reactor 40, on the one hand, complete mixing is enabled over the entire cross section of the stirring container 56 and, on the other hand, a blocking of the helical stirrer 12 by particles of media which are to be stirred (not shown) between the helical stirrer 12 and the inner wall is prevented.

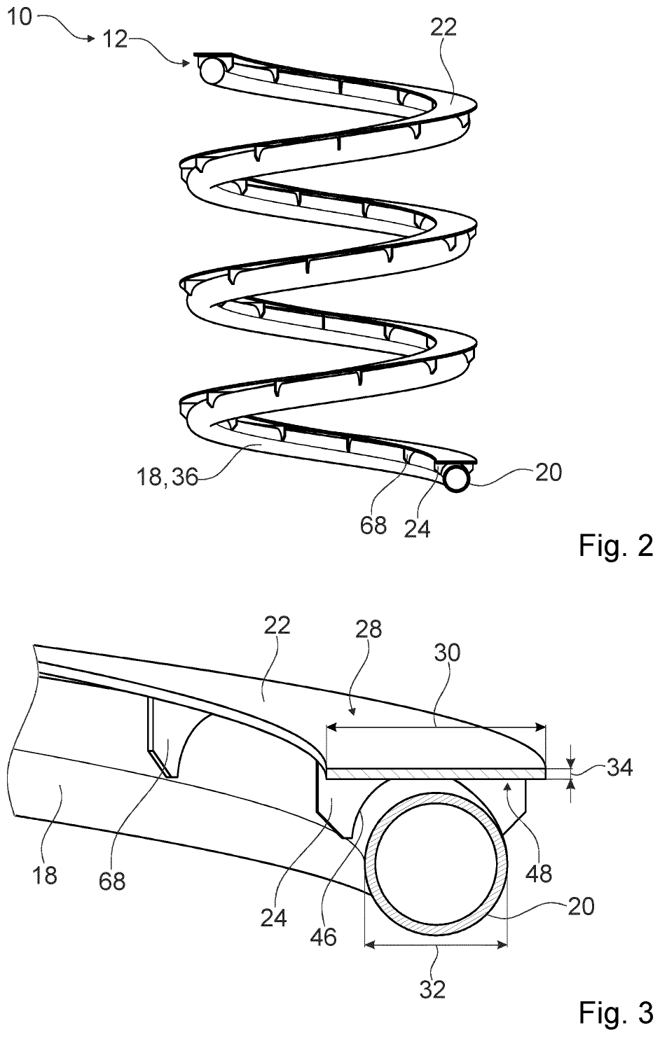

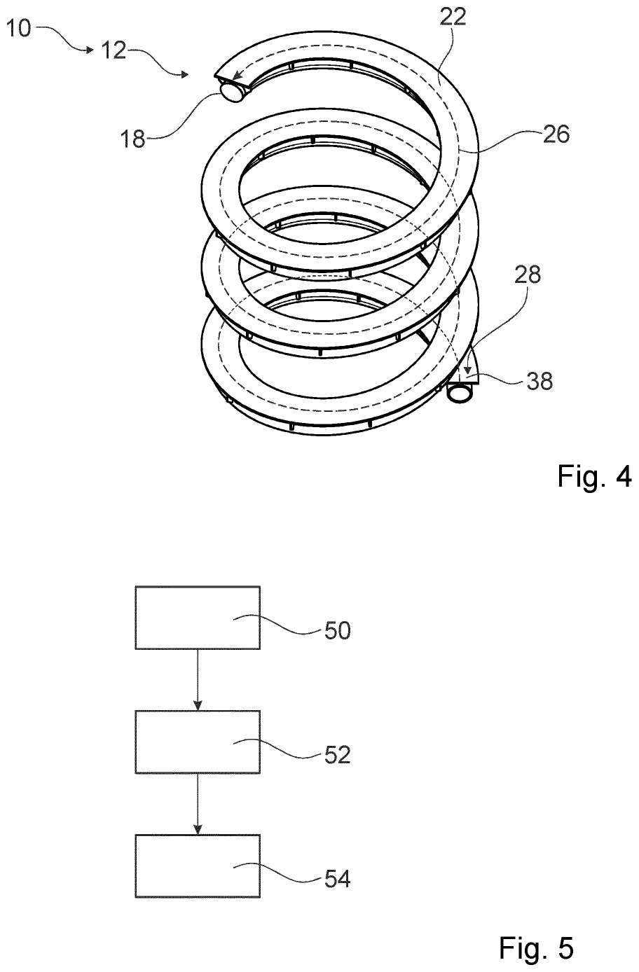

FIG. 2 shows a schematic side view of the stirring element device 10. The base body 18 of the helical stirrer 12 has in at least one cross-sectional view (cf. FIG. 3) an at least section-wise oval, in particular circle-shaped, outer contour 20. In the present case the outer contour 20 of the base body 18 is circle-shaped. In the present case the base body 18 has a section-wise oval, in particular circle-shaped, outer contour 20 in all cross-sectional views along a principal course 26 of the helical stirrer 12 (cf. FIG. 4).

The base body 18 is embodied as a tube 36. In the present case the tube 36 is embodied as a bent round tube.

The helical stirrer 12 comprises a stirring blade 22. The stirring blade 22 is connected to the base body 18.

The helical stirrer 12 comprises at least one connection element 24, which connects the stirring blade 22 to the base body 18. In the present case the helical stirrer 12 comprises a plurality of connection elements 24, namely the connection element 24 and a plurality of further connection elements 68. The connection element 24 and the further connection elements 68 are implemented substantially identically to one another, and are arranged spaced apart from one another.

The stirring blade 22 is connected to the base body 18 by substance-to-substance bond. In the present case the stirring blade 22 is connected to the base body 18 by indirect substance-to-substance bond via the connection element 24 and via the further connection elements 68.

FIG. 3 shows a schematic partial view of the helical stirrer 12 in a cross-sectional view onto the base body 18, showing a partial region of the base body 18 and of the stirring blade 22, respectively, and showing the connection element 24.

The connection element 24 has an arc-shaped inner contour 46, which encompasses the outer contour 20 of the base body 18 at least partially. In the present case the connection element 24 is connected, in this case welded, to the outer contour 20 of the base body 18 in the region of its inner contour 46.

The stirring blade 22 is on its underside 48 connected to the connection element 24 by substance-to-substance bond, in this case welded. The connection element 24 thus connects the stirring blade 22 to the base body 18 by indirect substance-to-substance bond. The stirring blade 22 is moreover connected to the base body 18 in the same way, by indirect substance-to-substance bond, via the further connection elements 68.

The stirring blade 22 has a transverse extent 30. In the cross-sectional view the transverse extent 30 of the stirring blade 22 is greater than a diameter 32 of the outer contour 20 of the base body 18.

The stirring blade 22 has a thickness 34 perpendicularly to the transverse extent 30. The thickness 34 of the stirring blade 22 is equivalent to maximally 20% of the diameter 32 of the outer contour 20 of the base body 18. In the present case the stirring blade 22 is implemented of a metal sheet having a small material thickness, which corresponds to the transverse extent 30.

FIG. 4 shows the helical stirrer 12 of the stirring element device 10 in a schematic perspective view. The base body 18 extends along the entire stirring blade 22, namely along the principal course 26 of the helical stirrer 12.

On a side 38 facing away from the base body 18 the stirring blade 22 has a planar surface 28.

FIG. 5 shows a schematic diagram for an illustration of a method for producing the stirring element device 10. In a first method step 50 the base body 18 of the helical stirrer 12 is produced from a tube 36 which has an at least section-wise oval, in particular circle-shaped, outer contour 20 (cf. FIG. 2). In the method step 50 the base body 18 is shaped from the tube 36 by a suitable shaping process. In a further method step 52 the connection element 24 and the further connection elements 68 are respectively connected to the base body 18, for example by a welding process. In a further method step 54 the stirring blade 22 is formed, preferably of a metal sheet having a thin material thickness, and is then connected to the base body 18 by way of the connection element 24 and the further connection elements 68 being respectively connected to the underside 48 of the stirring blade 22, for example by a welding process.

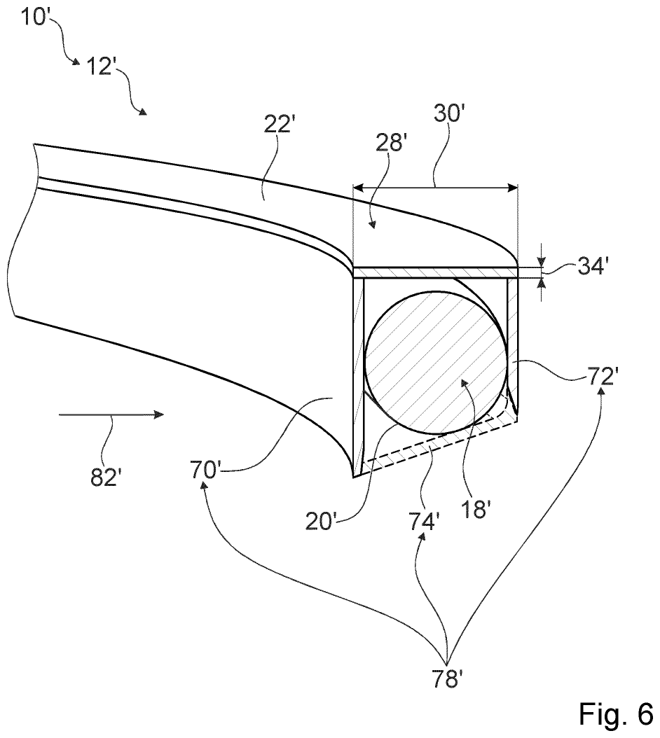

In FIG. 6 a further exemplary embodiment of the invention is shown. The following descriptions and the drawings are essentially limited to the differences between the exemplary embodiments, wherein in regard to components having the same denomination, in particular components having the same reference numerals, principally the drawings and/or the description of the other exemplary embodiment, in particular of FIGS. 1 to 5, may be referred to. In order to distinguish between the exemplary embodiments, a prime has been added to the reference numerals of the exemplary embodiment shown in FIG. 6.

FIG. 6 shows a further exemplary embodiment of a stirring element device 10′. The stirring element device 10′ comprises a helical stirrer 12′. The helical stirrer 12′ is rotatable around a rotation axis (not shown). The helical stirrer 12′ comprises a base body 18′. The base body 18′ has in the cross-sectional view an at least section-wise oval, in particular circle-shaped, outer contour 20′. Differently than the base body 18 in the preceding exemplary embodiment, the base body 18′ is made of a full profile. However, alternatively, in analogy to the preceding exemplary embodiment, the base body 18′ of the stirring element device 10′ could also be made of a tube.

The helical stirrer 12′ comprises a stirring blade 22′. The stirring blade 22′ is implemented substantially identically to the stirring blade 22 of the stirring element device of the preceding exemplary embodiments, therefore the description of FIGS. 1 to 5 may be referred to in regard to this.

The helical stirrer 12′ comprises a cover unit 78′. The cover unit 78′ comprises at least one cover element 70′, which extends along the entire base body 18′. In the present case the cover unit 78′ comprises the cover element 70′ and a further cover element 72′. The cover element 70′ is connected to the stirring blade 22′ by substance-to-substance bond, for example welded. The cover element 70′ is arranged at least substantially perpendicularly to a transverse extent 30′ of the stirring blade 22′. The first cover element 70′ is arranged on a side of the helical stirrer 12′ that faces toward a rotation axis (not shown). The further cover element 72′ is connected to the stirring blade 22′ by substance-to-substance bond, for example welded. The further cover element 72′ is arranged at least substantially perpendicularly to the transverse extent 30′ of the stirring blade 22′. The further cover element 72′ extends along the entire stirring blade 22′. The second cover element 72′ is arranged on a side of the helical stirrer 12′ that faces away from a rotation axis (not shown). The further cover element 72′ has in a direction that is perpendicular to the stirring blade 22′ a smaller extent than the cover element 70′.

In an optional implementation, the cover unit 78′ of the stirring element device 10′ comprises an additional cover element 74′. The additional cover element 74′ may be connected to the cover element 70′ and the further cover element 72′ in each case by substance-to-substance bond, for example by welding. The additional cover element 74′ is configured for a flow optimization. In an operating state of the stirring element device 10′, the additional cover element 74′ is in particular configured to create an optimized gas flow toward the further cover element 72′. In a mounted state of the additional cover element 74′, the base body 18′ is encompassed, perpendicularly to the cross-sectional view, in all directions by the stirring blade 22′, the cover element 70′, the further cover element 72′ and the additional cover element 74′.

For a description of a method for producing the stirring element device 10′, principally the description of FIG. 5 may be referred to, wherein in the further method step 54 additionally the cover element 70′ and the further cover element 72′ are respectively connected to, for example welded with, the stirring blade 22′. It is optionally further possible that in the further method step 54 moreover the additional cover element 74′ is respectively connected to, for example welded with, the cover element 70′ and the further cover element 72′.

### REFERENCE NUMERALS

10 stirring element device
12 helical stirrer
14 rotation axis
16 winding
18 base body
20 outer contour
22 stirring blade
24 connection element
26 principal course
28 surface
30 transverse extent
32 diameter
34 thickness
36 tube
38 side
40 agitation reactor
42 drive shaft
44 drive unit
46 inner contour
48 underside
50 method step
52 further method step
54 further method step
56 stirring container
58 further winding
60 further winding
62 main extent direction
64 connection point
66 rotation direction
68 further connection element
70 cover element
72 further cover element
74 additional cover element
76 wall clearance
78 cover unit
80 inner wall
82 direction

1. A stirring element device, in particular for stirring fluidized beds and/or solid matter mixtures and/or highly viscous suspensions, with at least one helical stirrer, which is rotatable around a rotation axis and has at least one winding that runs around the rotation axis, wherein the helical stirrer comprises a base body, which has in at least one cross-sectional view an at least section-wise oval, in particular circle-shaped, outer contour.

2. The stirring element device according to claim 1, wherein the helical stirrer comprises a stirring blade, which is connected to the base body.

3. The stirring element device according to claim 2, wherein the stirring blade is connected to the base body by substance-to-substance bond.

4. The stirring element device according to claim 2, wherein the helical stirrer comprises at least one connection element, which connects the stirring blade to the base body.

5. The stirring element device according to claim 2, wherein the base body extends along the entire stirring blade, in particular along a principal course.

6. The stirring element device according to claim 2, wherein the stirring blade has an at least substantially planar surface on a side facing away from the base body.

7. The stirring element device according to claim 2, wherein in the cross-sectional view a transverse extent of the stirring blade is greater than a diameter of the outer contour of the base body.

8. The stirring element device according to claim 2, wherein in the cross-sectional view the stirring blade has a thickness that is equivalent to maximally 20% of a diameter of the outer contour of the base body.

9. The stirring element device according to claim 1, further comprising a cover unit with at least one cover element, which extends at least partly along the base body, covering the base body at least partly in at least one direction that is perpendicular to the rotation axis.

10. The stirring element device according to claim 1, wherein the base body is embodied as a tube.

11. An agitation reactor with a stirring container and with a stirring element device according to claim 1.

12. The agitation reactor according to claim 11, wherein the helical stirrer is arranged in the stirring container in such a way that a wall clearance to an inner wall of the stirring container is optimized.

13. A method for producing a stirring element device, in particular according to claim 1, with at least one helical stirrer, wherein a base body of the helical stirrer is produced from a tube with an at least section-wise oval, in particular circle-shaped, outer contour.

14. The method according to claim 13, wherein a stirring blade of the helical stirrer is connected to the base body.
